(19) United States
(12) Patent Application Publication
(10) Pub. No.: US 2008/0087508 A1
(43) Pub. Date: Apr. 17, 2008

(54) DRUM BRAKE ADJUSTERS

(75) Inventors: Robert J. Lackowski, Mt. Prospect, IL (US); Michael E. Haber, Cary, IL (US)

Correspondence Address: VEDDER PRICE KAUFMAN & KAMMHOLZ, 222 N. LASALLE STREET, CHICAGO, IL, 60601, US

(73) Assignee: Kenmode Tool and Engineering, Inc., Algonquin, IL (US)

(21) Appl. No.: 11/549,749

(22) Filed: Oct. 16, 2006

(51) Int. Cl. F16D 51/00

(52) U.S. Cl. 188/79.51

(57) ABSTRACT

A method of manufacturing a drum brake engagement fork. The method includes selecting a blank of flat sheet material, forming the blank so as to have tongue portions on one side and grooves on the other side of said blank, forming a tube from the blank with the side seam interlocked, and coining the side seam thus formed, and then flattening one end portion prior to forming a pair of tines therein. It also provides an engagement or adjusting fork made by the above process.

### BACKGROUND OF THE INVENTION

The present invention relates generally to parts for automotive braking systems and more particularly, to a fixed part having a generally cylindrical, tubular portion with a fork on one end, and a second, cooperating part in the form of a threaded insert and an adjusting nut with a fork on its end, thus making a so-called adjusting fork assembly for drum brakes.

Whereas in the last ten or twenty years, there has been a great deal written about disc brakes and their advantages, there are still a huge number of vehicles having drum brakes in use, and a large number of such vehicles are being made every day in the United States and elsewhere. One of the advantages of drum brake systems is the ability to have the brakes adjusted with little or no difficulty, and without affecting the hydraulic system that operates the brakes.

The present invention involves an improvement to such a part of the adjustment mechanism and the method of making the part, and in particular, a tubular drum brake adjusting fork assembly. This fork includes a tube that is used with a threaded insert and another fork to maintain the brake shoes in a drum brake arrangement at a proper distance from the brake drum itself.

When the brake shoe is spaced too far from the brake drum, there is excessive free play in the brake pedal. Such excessive free-play results in poor braking ability, and in the ultimate case, an accident caused by malfunctioning brakes.

On the other hand, if the brake shoes are adjusted too tightly, that is, the shoe is too close to the brake drum, there is a dragging or continued engagement of the brake shoes with the brake drum. This causes excessive lining wear, and builds up excessive heat in the brake shoes and the brake drums.

Accordingly, it is necessary during the operation of a vehicle several times in its life, to have the brake shoes adjusted to a closer position, but not so close as to be in engagement at all times. Normally, brake drum adjustment is carried out by engaging an adjusting nut with a flat bladed screwdriver, a “spoon” made for this purpose, or the like. The adjusting nut is situated on a threaded insert received in the fork tube adjacent the pistons on a pair of brake shoes in a typical drum brake arrangement.

The adjuster mechanisms are positioned so that the brake cylinder pistons, which are typically at the top of a brake shoe mechanism, engage the shoes with the drums by pushing outward on the upper ends of the brake shoes. The lower ends of the brake shoes are normally pivotable, and the two brake shoes pivot about these two lower points. When the brakes are adjusted, the adjuster mechanism comes into play, and the adjustment pushes the top portions of the two brake shoes slightly more toward the brake drum.

Thereafter, the brake cylinder pistons continue to be actuated, and the brakes function normally until such time as they require a further adjustment. At this time, the nut or the adjuster mechanism is again engaged and the brake shoes are moved apart slightly, thereby bringing the shoes more closely toward contact, but still spaced from, the brake drums.

At the present time, the known and used adjuster mechanism has several potential shortcomings. The prior art adjuster mechanism includes a threaded insert with a fork on the end, an adjusting nut and a tubular portion with a fork on its end. The tubular part has usually been made from seamless tubing, and the current design requires that the tubing be cut to length, flattened, cut and shaved, and finally formed. There have been found other and better ways of making the brake adjuster tube.

The present invention provides parts that can easily meet, and well exceed, the strength requirement for this part. The tests require a certain compressive load strength in order to pass. The present method involves, instead of using seamless tubing, making a nearly cylindrical adjusting fork from flat stock, which has improved column strength for use on drum brakes.

It is therefore an object of the present invention to provide an improved, partly cylindrical brake adjusting fork.

Another object is to provide a partly cylindrical or purely cylindrical brake adjusting fork which is made by a novel method.

A still further object of the present invention is to manufacture a cylindrical drum brake adjusting fork by a method which includes forming a blank from flat sheet material, forming plural tongues on one side of the blank and complementary grooves on the other side, forming a tube from such a blank by curling the flat sheet into a tubular shape and interlocking the tongue and groove portions to form a side seam.

Another object of the present invention is to provide to a side seam made from tongue and groove portions of the same sheet that fully interlock with each other by a coining operation which completes forming the tube and increases the strength of the joint thus formed.

Another object is to deform the one end portion of the tube, formed as described above, to form a fork with a pair of tines and a spring-retaining groove in the flat portion.

A further object is to perform a method which includes forming a tube from flat stock, flattening a portion of the tube, forming a fork having two times in the front portion, and bending one end portion of one of the fork tines upward at an angle, thereby creating a cylindrical drum brake adjusting fork with two angularly related tines.

Another object is to provide an adjusting fork for drum brakes which may be used with the remainder of ordinary parts, without any further additions or adjustments.

A still further object is to create an adjusting fork for drum brakes which include a threaded forked insert which fits into the interior of the tubular adjusting fork and contains an adjusting nut or like component which, when used with the fork, serves to maintain a compressive load on the adjuster mechanism.

### SUMMARY OF THE INVENTION

The invention accomplishes its objects and other inherent objects by manufacturing a drum brake adjusting fork, including selecting a blank of flat sheet material, forming the blank so as to have tongue portions on one side and grooves on the other side of said blank, forming a tube from the blank with the side seam interlocked, and coining the side seam thus formed, and then flattening one end portion of the tube prior to forming the end portion into a pair of tines and a spring retaining groove in the flat portion. It accomplishes its objects also by providing an adjusting fork made by the above process.

The manner in which these objects and other objects and advantages of the invention are achieved in practice will become more clearly apparent when considered in conjunction with the description of the preferred embodiment of the invention set forth by way of example and shown in the accompanying drawings, in which like reference numerals indicate corresponding parts throughout.

### BRIEF DESCRIPTION OF THE DRAWINGS

FIG. 1 is a somewhat schematic, enlarged side elevational view of a brake drum, the backing plate and a part of the actuating mechanism for the brake shoes, and including the brake adjuster assembly and tensioning spring of the present invention;

FIG. 2 is an enlarged perspective view of the adjuster fork tube of the present invention, with a complementary threaded adjusting nut and a tensioning spring;

FIG. 3 is a further enlarged end elevational view of the novel brake adjustment tube, showing the preferred slightly oval configuration of the adjuster body in one embodiment;

FIG. 4 is a top plan view of the tubular component of the invention, showing the interlocked side seam, the spring notch and the bifurcated end portions of the tubular component;

FIG. 5 is a side elevational view of the tubular brake adjustment component of the invention, showing the upturned end portion of one of the forks; and

FIG. 6 is a top plan view of a strip of sheet steel, showing a succession of the various steps in manufacturing the brake adjustment tube of the present invention.

### DESCRIPTION OF THE PREFERRED EMBODIMENTS OF THE INVENTION

While the present invention may be embodied in different forms and there may be some variations in the preferred form in which the invention is carried into practice, a description will be given of a presently preferred embodiment of the invention.

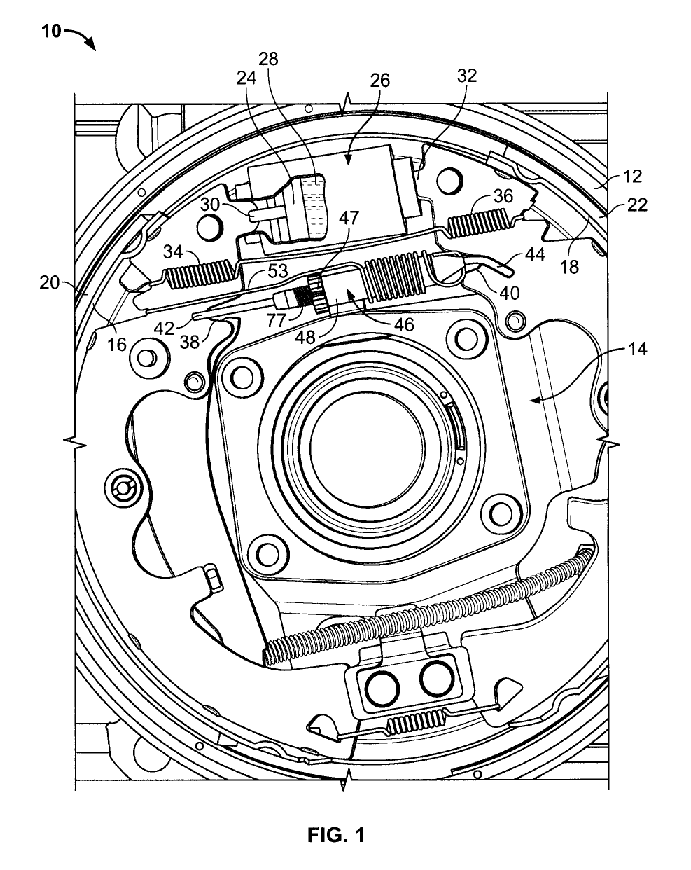

Referring now to the drawings in greater detail, there is shown in FIG. 1 a somewhat schematic view of a brake drum assembly generally designated 10 which includes a rotary circular brake drum 12 and a stationary backing plate generally designated 14. The backing plate 14 mounts a pair of brake shoes 16, 18 having brake linings 20, 22 thereon.

The shoes and brake linings are normally actuated by a pair of oppositely disposed pistons (only one shown) 24, which are received within a slave cylinder generally designated 26 for actuation. The slave cylinder 26 receives its fluid 28 under pressure from a master cylinder (not shown) as is well known in the art. The pistons each have end portions 30, 32 adapted to push the shoes 16, 18 apart and into engagement between the linings 20, 22 and the drum 12 when the brake pedal (not shown) is actuated. There are two return springs 34, 36 to return the shoes 16, 18 and their linings 20, 22 to their retracted positions whenever the brake pedal and master cylinder have not put the slave cylinder(s) 26 under pressure.

Each upper portion of the shoes 16, 18 has a pocket 38, 40 for receiving the end portion 42, 44 of the adjuster mechanism generally designated 46. The adjustment mechanism 46 includes a rotary toothed adjusting wheel or nut 47 for engagement by the flat blade portion of an adjusting tool (e.g., a “spoon”) a screwdriver or the like (not shown). This moves the adjuster mechanism to cause the pockets 38, 40 and hence the shoes 16, 18 to move slightly farther apart.

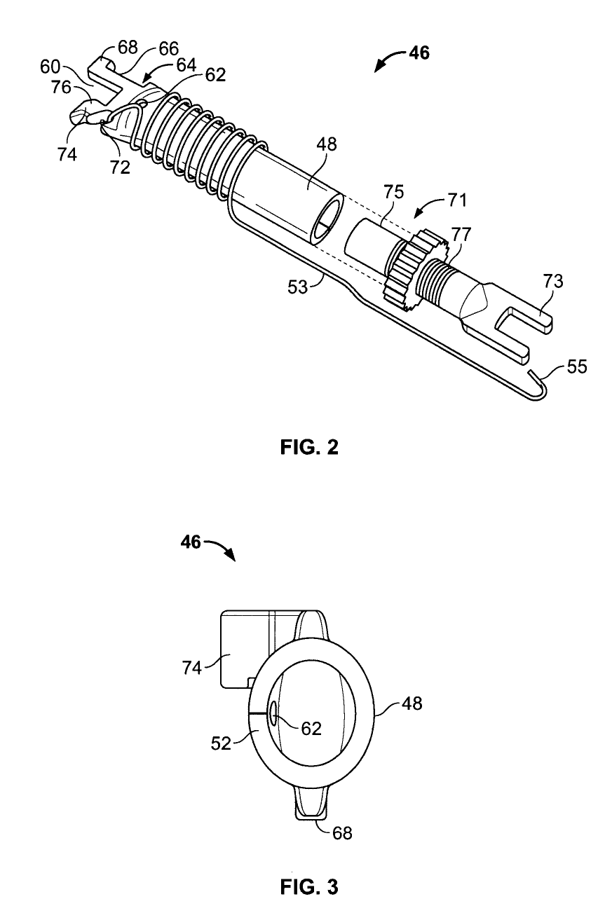

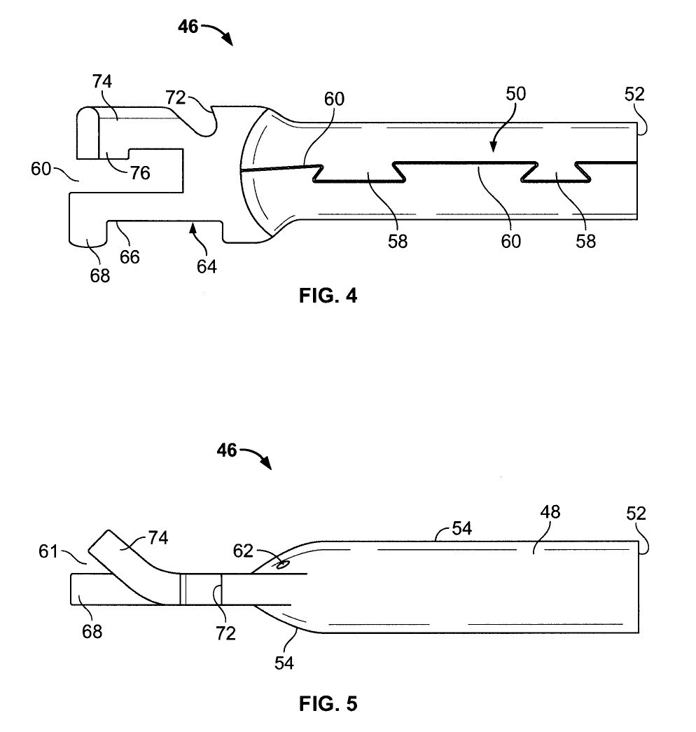

The adjustment mechanism generally designated 46 (FIGS. 2-6) includes a tubular body portion 48 having a side seam generally designated 50. An end view (FIG. 3) of the adjuster generally designated 46 shows that one end 52 portion of the adjuster 46 is slightly oval shaped. A tapered portion 54 of the adjuster body 46 is shown on the end opposite the preferably somewhat oval end 52. The side seam generally designated 50 includes plural tongues 58 and plural grooves 60. When the blank is curved or formed so as to engage the plural tongues with the plural grooves 60, the tongues and groove interlock, and, after coining, take on the shape shown in FIG. 4. The adjuster 46 also has an optional drain opening 62 about which reference will be made elsewhere herein.

The adjuster 46 also includes, at one end, a first fork generally designated 64 having a longitudinal notch 66 in the body and an end portion 68 of enlarged width. The adjuster 46 also includes a cut-out central opening 60, a spring groove 72 cut in an angled portion 74 with a slight inward enlargement 76.

Moreover, the adjuster assembly includes a threaded insert generally designated 71 having a bifurcated end portion 73 adjusted to snugly engage the pocket 44 in the brake shoe 18, a plain shank portion 75 and a threaded portion 77. The adjusting nut 47 engages the threaded portion. The insert fits snugly within the tubular portion 48 of the adjuster assembly. A spring 53 holds the two elements 46, 71 together by engaging the spring groove and the shoe 16 and urging them together.

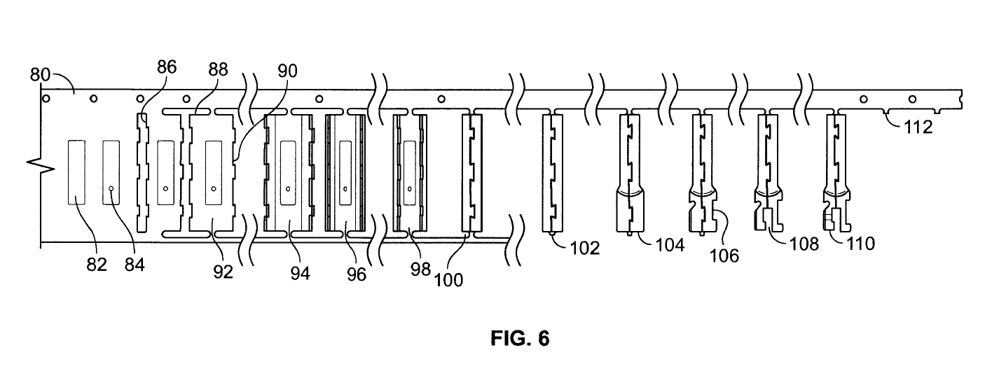

Referring now to FIG. 6, a preferred method of making the brake adjuster 46 of the present invention is illustrated. This operation is carried out in a multi-stage transfer press wherein stamping and forming is carried out. It will be understood that there are numerous idler stations in between the illustrated stations for every step. Here, there is shown a continuous sheet 80 of the steel from which the brake adjuster 46 is made.

First, a rectangular impact area 82 is stamped from one section of the sheet 80. The next operation involves piercing the drain opening 84 in the being-formed sheet 80. The outline cut 86 is next, and this forms a partial edge portion of the blank.

The next step is an elimination of the border and manufacture of a partial end portion within the outline 88. The individual flat blank 92 is then formed, except for the edge portion binding the blank 92 to the sheet 80, and with the tongue and groove portions in place within the flat blank 92. The next operation calls for slightly forming a curl in the blank 94, and then a somewhat more curved or moderately curved blank 96 is formed. A deeply curved blank 98 is then formed, and finally the sheet 100 is formed into a complete tube with the side portions interlocked.

Next, the schematic shows coining 102 of these seamed components, thus adding considerable strength and work hardening the material. The next stage consists of forming a flat end portion 104 with the tongue and groove in the tube and end portions being intact.

In the next section, additional cuts are made, thus forming the spring groove and the longitudinal notch in the blank 106. Additional notches 108 are cut from this blank, in the next station, and the material assumes its penultimate form. The final station 110 involves bending upwardly one of the fork tines thus formed.

Thereupon, the last step shows the adjuster removed from the tabbed portion 112, having been eliminated from the continuous formation strip.

The parts of the prior art previously were made from seamless steel tubing that was then flattened on the end, and cut to produce the current design. The basic flaw with that method is that the finished part proved to lack the desired strength, particularly column strength. During tests, which consisted of an offset column loading, the parts buckled relatively easily within the applicable strength range. Thus, the prior art design had a column loading requirement of 13,500 Newtons. A part made according to the prior art was tested. This part failed at 12,422 Newtons. This was well short of the requirement of 13,500 Newtons.

Two additional specimens made according to the instant method were tested, and these gave what was believed to be satisfactory results. Thus, second part failed at 14,130 Newtons and the third part failed at 15,618 Newtons.

These two parts, which failed at just over 14,000 to 15,600 Newtons, would exceed the strength requirement that was mandated; however, higher values were believed within easy reach.

Consequently, when it was discovered that these test samples were erroneously placed in the fixture, new tests were made, and four samples were created. Against the load requirement of at least 13,500 Newtons, the new samples were tested. The least strong failed at 17,137 Newtons and the other three all exceeded 18,000 Newtons. Hence, this was considered an excellent success and this design was then settled upon.

The material from which the test specimens were made was grade 1010 (mild steel) which also exceeded substantially the force requirements. 1010 steel, while meeting the requirements, is considerably less expensive than some of the other steels which were used. In addition, an HSLA (high strength, low alloy) steel could be used for even greater strength.

There are several instances in which these parts are plated for appearance and/or for reduction of rust and other reasons. The plating of these parts is carried out in an immersion bath coating the interior as well as the exterior. The parts are thoroughly wetted and current is then passed through the tubular unit in one instance. In some cases, however, the liquid plating bath was inadvertently retained within the interior of the unit, even after the plating was supposedly completed.

Consequently, it was determined that a drain hole 62 should be placed in these units so that, during handling, any liquid which was retained in the interior because of the orientation of the parts would drain from the material. If a unit were placed in one way, the liquid would be drained from the bottom. If they were placed in a slightly different environment, then the drain hole would be necessary to relieve the accumulation of plating bath in the interior of the parts.

It will thus be seen that the present invention provides a novel product and method of making it, having a number of advantages and characteristics including those specifically pointed out and others which are inherent in the invention.

What is claimed is:

1. A method of making a generally cylindrical drum brake adjusting fork from a blank of flat sheet material, comprising the steps of cutting a blank of flat metal material so as to present a blank with plural, interlocking areas on each side, forming a tube from said blank by curling said flat sheet into a tube and bringing said interlocking areas into engagement to form a side seam in said tube, thereby creating a tubular body, coining said side seam portions of said tube to stiffen said tubular body, flattening one end portion of said tubular body, forming a fork in said end portion of said tubular body with a pair of tines, and forcing a portion of one of the tines upward at an angle, thereby creating a brake adjusting fork having a tubular body portion and two tine portions angled with respect to each other.

2. A method as defined in claim 1 wherein said interlocking portions are at least three tongues on one side of said blank and at least three grooves on the other side of said blank.

3. A method as defined in claim 1 which includes forming a space between said tines.

4. A method as defined in claim 1 which includes forming a spring-retaining groove in said flat portion of said finished product.

5. A method as defined in claim 1 which includes forming a drain hole in said tube.

6. A method as defined in claim 1 wherein said metal is steel.

7. A method as defined in claim 1 wherein said metal is mild (1020) steel.

8. A method as defined in claim 1 wherein said metal is HSLA steel.

9. A brake drum adjusting fork made by the method of claim 1.

10. A method of making a generally cylindrical drum brake adjusting fork from a blank of flat sheet steel material, comprising the steps of cutting a blank of flat sheet steel material so as to present a blank with at least three tongues on one side and at least three grooves on the other side, forming a tubular body from said blank by curling said flat sheet into a generally tubular shape and interlocking said tongue and groove portions to form a side seam in said tubular body, coining said side seam portions of said tube to stiffen said tubular body, flattening one end portion of said tubular body, forming a fork in said one end portion with a pair of tines and a space between said tines, forming a groove in said flat portion, and forcing one end portion of one of the tines upward at an angle, thereby creating a brake adjusting fork having a tubular body portion and angularly related tines.

11. A method as defined in claim 9 which further includes forming a drain hole in said tubular body.

12. A brake drum adjuster body made by the method of claim 10.

13. A brake drum adjuster having a body portion with one end being an approximately circular cylindrical body portion, formed from a blank having two opposed edges of said blank interlocked with each other, and having said edges coined, and the other end of said body having a flat end portion with two times extending from said flat end portion, one of said times portions being a first fork tine and extending straight out and coplanar with said flat portion, and the other being a second fork tine extending at an angle to said first fork tine, and having a spring-receiving groove in said flat portion.

14. A brake drum adjuster as defined in claim 13 wherein said adjuster is made from a mild (1020) steel.

15. A brake drum adjuster as defined in claim 13 wherein said adjuster is made from a HSLA steel.
